(19) United States
(12) Patent Application Publication
(10) Pub. No.: US 2007/0192862 A1
(43) Pub. Date: Aug. 16, 2007

(54) Automated containment of network intruder

(76) Inventors: Vincent Vermeulen, Newbury Park, CA (US); John David Matthews, Katy, TX (US)

Correspondence Address: ALCATEL INTERNETWORKING, INC., ALCATEL-INTELLECTUAL PROPERTY DEPARTMENT, 3400 W. PLANO PARKWAY, MS LEGL2, PLANO, TX, 75075, US

(21) Appl. No.: 11/568,914

(22) PCT Filed: Dec. 21, 2004
(86) PCT No.: PCT/IB04/04457

§ 371 Date: Nov. 10, 2006

Related U.S. Application Data
(60) Provisional application No. 60/570,962, filed on May 12, 2004.

(51) Int. Cl. G06F 12/14

(52) U.S. Cl. 726/23

(57) ABSTRACT

The invention in the preferred embodiment features a system (200) and method for automatically segregating harmful traffic from other traffic at a plurality of network nodes including switches and routers. In the preferred embodiment, the system (200) comprises an intrusion detection system (105) to determine the identity of an intruder and a server (130) adapted to automatically install an isolation rule on the one or more network nodes (114, 115, 116) to quarantine packets from the intruder. The isolation rule in the preferred embodiment is a virtual local area network (VLAN) rule or access control list (ACL) rule that causes the network node to route any packets from the intruder into a quarantine VLAN or otherwise isolate the traffic from other network traffic. In large networks, the isolation rule may be installed on a select plurality of network nodes under the gateway router (104) associated with the node at which the intruder first entered the network (100).

### TECHNICAL FIELD

The invention relates to a mechanism for isolating traffic from an intruder across a data communications network. In particular, the invention relates to a system and method for distributing isolation rules among a plurality of network nodes to route traffic from the intruder into a dedicated virtual local area network (VLAN) or otherwise segregate the traffic.

### BACKGROUND ART

In today's highly mobile computing environments, mobile client devices can readily migrate between various networks including home and enterprise networks, for example. In the process, the client devices are more prone to transport files that introduce problems within the enterprise network. The problems may include, but are not limited to, the introduction of malicious worms into the enterprise network which may damage computers throughout the network and be costly to remove. One contemporary approach for limiting the scope of these problems is to install an Intrusion Detection System (IDS) or Intrusion Prevention System (IPS) between network segments of the enterprise network to inhibit the spread of a worm, or to outright disable entire portions of the network to prevent the propagation of a worm outside the infected area. These approaches, however, severely impact network operation and may only temporarily contain the problem device to a section of the network. Other machines on the network may still become infected if a laptop computer or personal digital assistant (PDA), for example, moves from a disabled portion of the network to an operable network segment where vulnerable machines are again infected. Despite best efforts, an entire network may still become infected.

Even if the spread of a malicious worm is isolated within a portion of the network, the network operators still need to determine the location of the offending machine. Although there are some automated methods for locating these devices on the network, including the Locator application in ALCATEL OMNIVISTA™ 2500, there is currently no mechanism for automatically denying access to an offending device at its entry point, and the network more generally, in response to an intrusion detection. There is therefore a need for a system to automatically deny an intruder access across the network in response to an intrusion detection at any point in the network.

### DISCLOSURE OF INVENTION

The invention in the preferred embodiment features a system and method for protecting network resources in a data communications network by automatically segregating harmful traffic from other traffic at each of a plurality of points that the harmful traffic may enter the network, thereby inoculating the entire network from an intruder. In the preferred embodiment, the system comprises one or more network nodes; an intrusion detection system to determine the identity of an intruder; and a server, operatively coupled to the intrusion detector, adapted to automatically: generate an isolation rule associating the identified intruder with an isolation action, and install the isolation rule on each of the one or more network nodes, such that each of the one or more nodes executes the isolation action upon receipt of a protocol data unit (PDU) from the identified intruder.

In the preferred embodiment, the network nodes may include routers, bridges, multi-layer switches, and wireless access points in a local area network, for example. Thus, when an intruder is detected by an IDS or IPS and its source media access control (MAC) address, Internet Protocol (IP) address, or both determined, the system of the preferred embodiment issues a virtual local area network (VLAN) rule or access control list (ACL) rule, for example, to the plurality of switching devices instructing the devices to route any packets from the intruder into a quarantine VLAN or otherwise isolate the traffic from other network traffic. In large networks, the gateway router associated with the switching device at which the intruder first entered the network may be determined by querying the ARP information throughout the network and the isolation action then installed on a select number of switching devices under the gateway router.

One skilled in the art will recognize that with the present invention, an offending device may be automatically denied access to an entire network at every entry point into the network in a matter of seconds with reduced network administrator participation and reduced cost. Installation of a quarantine VLAN rule or ACL rule on enterprise switches, for example, can prevent a virus from spreading between clients accessing the same switch as well as clients of different switches without an intermediate firewall. That is, installation of a quarantine rule can prevent the spread of virus between (a) clients coupled to the same switching device as well as (b) clients that are remotely separated whether or not the clients are separated by a firewall, for example.

### BRIEF DESCRIPTION OF THE DRAWINGS

The present invention is illustrated by way of example and not limitation in the figures of the accompanying drawings, and in which:

FIG. 1 is a functional block diagram of a network adapted to automatically contain network intruders, in accordance with the preferred embodiment of the present invention;

FIG. 2 is a functional block diagram of a switch adapted to perform intruder detection response (IDR), in accordance with the preferred embodiment of the present invention;

FIG. 3 is a functional block diagram of an AQE server, in accordance with the preferred embodiment of the present invention;

FIG. 4 is a flowchart of the process for distributing intruder isolation rules from an AQE server, in accordance with the preferred embodiment of the present invention;

FIG. 5 is a flowchart of the process for distributing intruder isolation rules to a plurality of IDR switches, in accordance with the preferred embodiment of the present invention; and

FIG. 6 is a sequence diagram of the response of an AQE server and IDR switches to an intruder, in accordance with the preferred embodiment of the present invention.

### BEST MODE FOR CARRYING OUT THE INVENTION

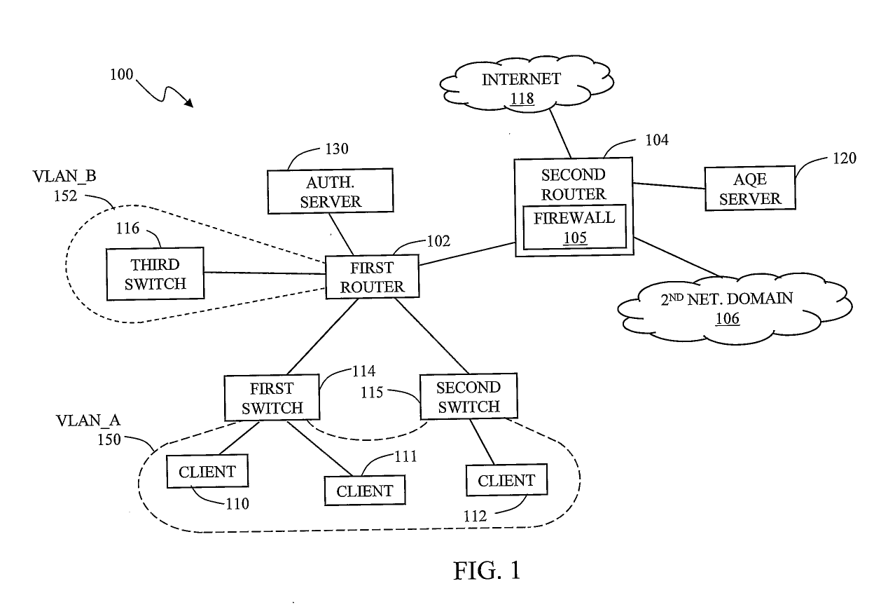

Illustrated in FIG. 1 is a functional block diagram of an enterprise network adapted to perform Intrusion Detection and Prevention (IDP) by automatically containing network intruders. The enterprise network 100 includes a plurality of nodes and other addressable entities operatively coupled to a data communications network embodied in a local area network (LAN), wide area network (WAN), or metropolitan area network (MAN), an Internet Protocol (IP) network, the Internet, or a combination thereof, for example.

The enterprise network 100 in the preferred embodiment includes a plurality of multi-layer switching devices—including a first router 102, second router 104, first switch 114, second switch 115, and third switch 116—as well as an authentication server and Automatic Quarantine Enforcement (AQE) sever 120. The second router 104, which serves as a gateway to the Internet 118, is operatively coupled to a first network domain, a second network domain 106, and the AQE sever 120. The first router 102 serves as the default router for the first network domain comprising the multi-layer local area network (LAN) switches 114-116. The first switch 114 and second switch 115 are operatively coupled to clients 110-112 in a first virtual local area network (VLAN), i.e., VLAN_A, while the third switch 116 is associated with end stations (not shown) in a second VLAN, i.e., VLAN_B. The second network domain 106 may further include one or more nodes associated with the first VLAN, second VLAN, or both. The multi-layer switching devices of the preferred embodiment may be routers, switches, bridges, or network access points, for example.

The first network domain and second network domain 106 and Internet 118 are operatively coupled via the second router 104, which further includes an intrusion detection system (IDS) adapted to monitor data traffic transmitted to or through the second router 104 for the presence of harmful or otherwise unauthorized traffic. The IDS is can also be a firewall 105 adapted to detect worms and viruses, for example, which are available from Netscreen Technologies, Inc. of Sunnyvale, Calif., Fortinet of Sunnyvale, Calif., and Tipping Point of Austin, Tex. In accordance with the preferred embodiment, the plurality of switching devices including the second router 104 may be further adapted to confine or otherwise restrict the distribution of harmful traffic flows with a quarantine VLAN different than the first and second VLANs. As described below the traffic in the quarantine VLAN consists essentially of PDUs that are associated with an intruder or a suspicious flow identified by the IDS.

In accordance with the preferred embodiment, the network further includes an automatic quarantine enforcement (AQE) server 120 adapted to distribute and install isolation rules among one or more network nodes in response to an intrusion detection. The AQE server 120 is preferably a central management server operatively coupled to the firewall 105 via the second router 104, although it may also be integral to the second router or other node in the network.

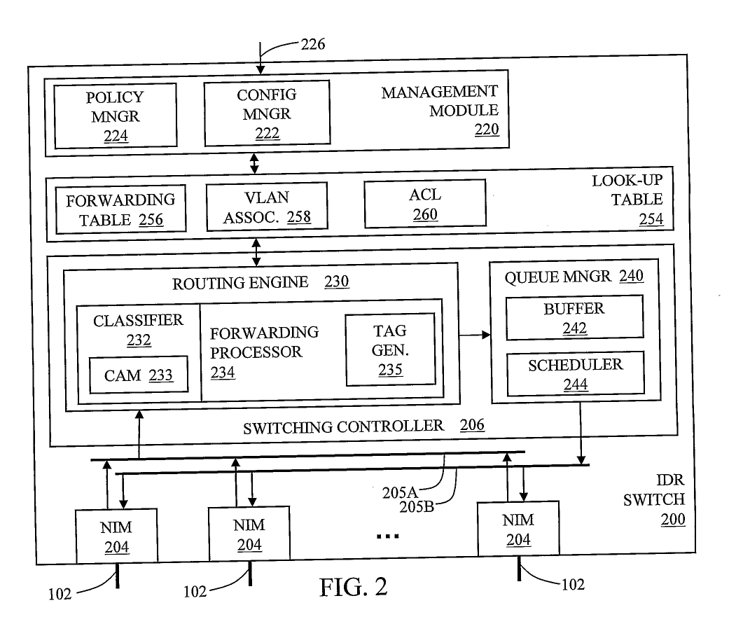

Illustrated in FIG. 2 is a functional block diagram of a switch adapted to perform intruder detection response (IDR) in accordance with the preferred embodiment. The switch 200 of the preferred embodiment comprises one or more network interface modules (NIMs) 204, one or more switching controllers 206, and a management module 220, all of which cooperate to receive ingress data traffic and transmit egress data traffic via each of the external ports 102. For purposes of this embodiment, data flowing into the switch 200 from another network node is referred to herein as ingress data, which comprises ingress protocol data units (PDUs). In contrast, data propagating internally to an external port 102 for transmission to another network node is referred to as egress data, which comprises egress PDUs. Each of the plurality of the external ports 102 is a duplex port adapted to receive ingress data and transmit egress data.

The NIMs 204 preferably include one or more ports 102 with a physical layer interface and media access control (MAC) interface adapted to exchange PDUs, e.g., Ethernet frames, with other nodes via network communications links (not shown). The ingress PDUs are conveyed from the plurality of NIMs 204 to the switching controller 206 by means of one or more ingress data buses 205A. Similarly, the egress PDUs are transmitted from the switching controller 206 to the plurality of NIMs 204 via one or more egress data buses 205B.

The management module 220 generally comprises a policy manager 224 for retaining and implementing traffic policies including isolation rules discussed in more detail below. The policies implemented by the policy manager 224 include forwarding information 256 based in part on Layer 2 (data link) addressing information derived from source learning operations and Layer 3 (network) route information received from other routing devices, VLAN association rules 258, and access control list rules 260 originating from the AQE server 120 or network administrator via a configuration manager 222 my means of simple network management protocol (SNMP) messages 226, for example. The forwarding rules, VLAN association rules, and access control policies are made available to the routing engine 230 and collectively represented by the look-up table 254.

The switch 200 preferably comprises at least one switching controller 206 capable of, but not limited to, Layer 2 (Data Link) and Layer 3 (Network) switching operations as defined in the Open Systems Interconnect (OSI) reference model. The set of possible Layer 2 protocols for operably coupling the external ports 102 to a wired and/or wireless communications link include the Institute of Electrical and Electronics Engineers (IEEE) 802.3 and IEEE 802.11 standards, while the set of possible Layer 3 protocols includes Internet Protocol (IP) version 4 defined in Internet Engineering Task Force (IETF) Request for Comment (RFC) 791 and IP version 6 defined in IETF RFC 1883.

The switching controller 206 preferably comprises a routing engine 230 and a queue manager 240. The routing engine 230 comprises a classifier 232 that receives ingress PDUs from the data bus 205A, inspects one or more fields of the PDUs, classifies the PDUs into one of a plurality of flows using a content addressable memory 233, and retrieves forwarding information from the look-up table 254 and forwards the PDUs to the appropriate VLANs if access to the switch 200 and associated network domain is authorized. The forwarding information retrieved from the forwarding table 256 preferably includes, but is not limited to, a flow identifier used to specify those forwarding operations necessary to prepare the particular PDU for egress, for example.

The forwarding processor 234 receives the ingress PDUs with the associated forwarding information and executes one or more forwarding operations prior to transmission to the appropriate egress port or ports. The forwarding operations preferably include but are not limited to header transformation for re-encapsulating data, VLAN tag pushing for appending one or more VLAN tags to a PDU using a VLAN tag generator 236, VLAN tag popping for removing one or more VLAN tags from a PDU, quality of service (QoS) for reserving network resources, billing and accounting for monitoring customer traffic, Multi-Protocol Label Switching (MPLS) management, authentication for selectively filtering PDUs, access control, higher-layer learning including Address Resolution Protocol (ARP) control, port mirroring for reproducing and redirecting PDUs for traffic analysis, source learning, class of service (CoS) for determining the relative priority with which PDUs are allocated switch resources, and color marking used for policing and traffic shaping, for example.

After the forwarding processor 234, the PDUs are passed to and stored in the queue manager 240 until bandwidth is available to transmit the PDUs to the appropriate egress port or ports. In particular, the egress PDUs are buffered in one or more of a plurality of priority queues in the buffer 242 until they are transmitted by the scheduler 244 to the external port 102 via the output data bus 205B.

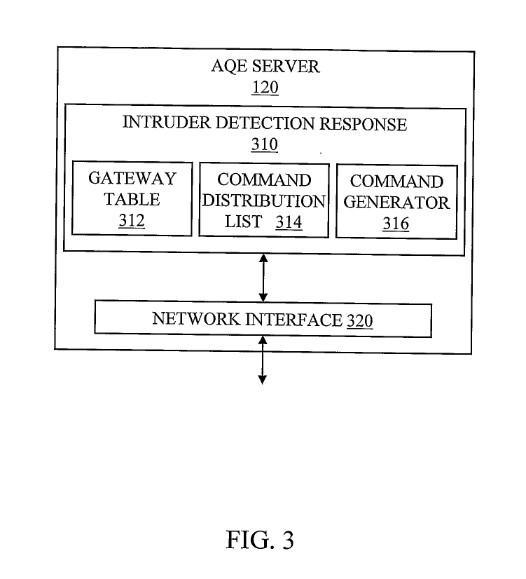

Illustrated in FIG. 3 is a functional block diagram of an automatic quarantine enforcement server. The AQE server 120 comprises an intruder detection response module 310 with a script generator 312 adapted to receive an intruder detection notice from the firewall 105 via the network interface 320. The intruder detection response module 310 also includes a script distribution list 314 identifying a plurality of default routers associated with the plurality of network domains in the enterprise network 100 to which the generated scripts are to be distributed.

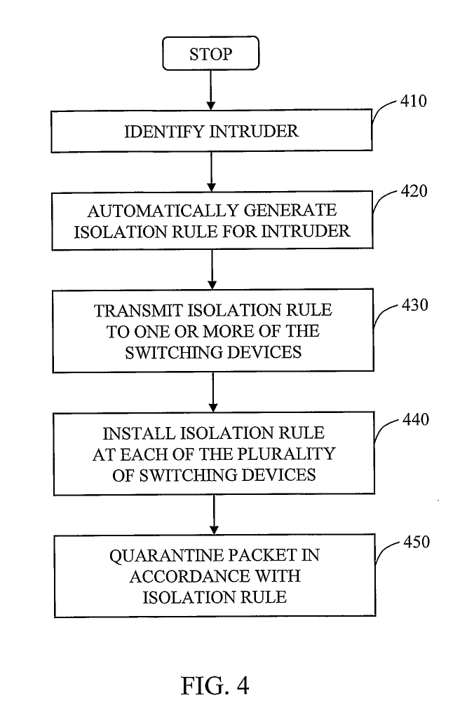

Illustrated in FIG. 4 is a flowchart of the process for distributing intruder isolation rules from an AQE server. In the preferred embodiment, the firewall 105 or other intruder IDS identifies (410) an intruder and provokes the AQE server 120 to automatically produce one or more programming commands using a programming/scripting language referred to as Perl. The commands are SNMP set commands produced by a Perl script are communicated to the switches via SNMP. In the preferred embodiment, the Perl scripts are used to generate an intruder isolation rule (420) to segregate related PDUs from conventional traffic, and distribute (430) the commands with the isolation rule to one or more nodes in the network. Upon receipt of the SNMP command, the one or more nodes executes the command to install/apply (440) the intruder isolation rule, thus enabling the switching devices to quarantine (450) any additional packets fitting the profile of the detected intruder. Upon installation of the isolation rule, the switching devices are able to prevent other end nodes in the domain from being exposed to suspicious packets even if the client relocates to a new point of entry into the domain.

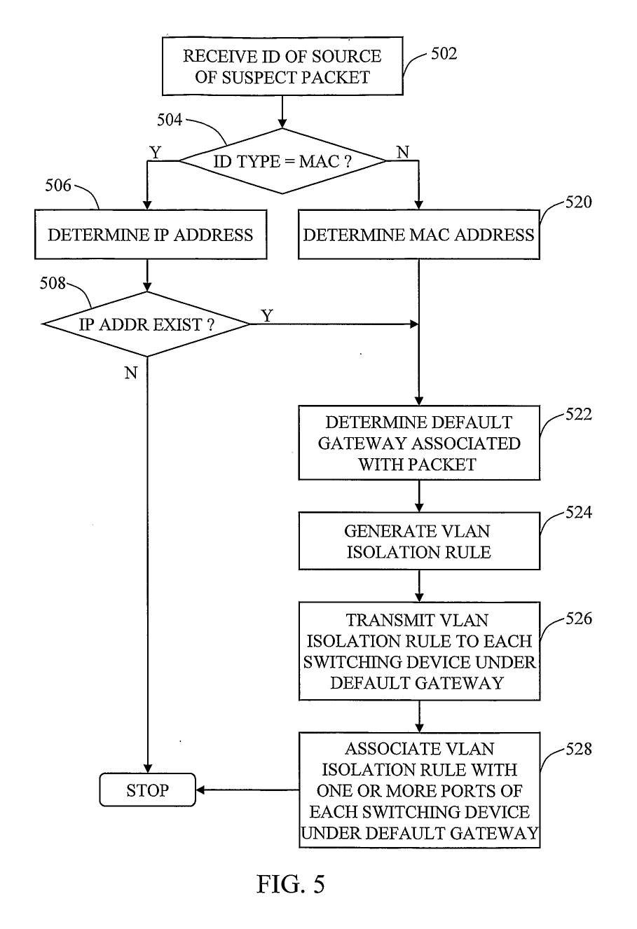

Illustrated in FIG. 5 is a flowchart of the process for automatically generating and distributing intruder isolation rules to a plurality of IDR switches in an enterprise network. To stimulate the procedure for isolating the intruder, the firewall 105 is configured to transmit the intruder detection notice to the AQE server 120. The intruder detection notice may include a simple network management protocol (SNMP) trap or syslog message, for example. In the preferred embodiment, the intruder detection notice includes an intruder profile or signature with an intruder identifier, e.g. the source address, of the suspicious packet. The source address is generally a media access control (MAC) address or Internet Protocol (IP) address. If the identifier is a MAC address, the ID type testing step (504) is answered in the affirmative and the AQE server 120 proceeds to determine (506) the IP address of the intruder by querying an ARP table query via SNMP to each of the default gateways identified in configuration file referred to herein as the script distribution list 314.

If the identifier type is an IP address, the ID type testing step (504) is answered in the negative and the AQE server 120 proceeds to determine the MAC address of the intruder. The AQE server 120 preferably transmits (520) an ARP table query via SNMP to each of the default gateways identified in the script distribution list 314. The default gateway associated with the end node that produced the suspicious packet will have a record of the intruder and return (522) the intruder's MAC address when its address resolution protocol (ARP) table is queried. Knowing the MAC of the intruder, the AQE server 120 preferably generates (524) an SNMP command set with an isolation rule that causes a switching device to segregate all packets having the intruder's source MAC address from uninfected traffic. The isolation rule in the preferred embodiment is a VLAN rule for bridging all packets from the intruder into a quarantine VLAN, although ACL rules may also be employed to segregate suspicious packets. Knowing the IP address, the AQE server 120 transmits (526) the commands with the VLAN isolation rule to each of the switches and routers within the domain headed by the default gateway.

Upon receipt, the script is executed and the VLAN or ACL isolation rule incorporated (528) into the VLAN association table 258 or ACL 260 where it causes any packet with the intruder's MAC address to be segregated if received on any edge or bridge port. The VLAN or ACL isolation rule may also cause the receiving switch to flush the MAC address of the intruder from its forwarding table 256. If configured to install the VLAN isolation rule on all switches in the network, however, the AQE server 120 need not determine the IP address of the intruder or identify a default router.

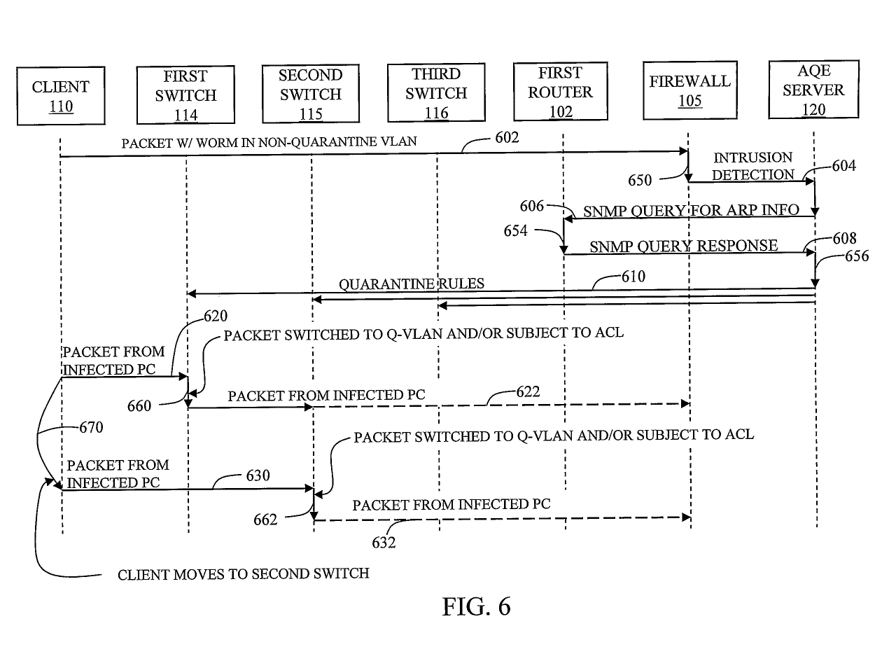

Illustrated in FIG. 6 is a sequence diagram of the response of an AQE server and IDR switches to an intruder. PDUs produced by the end nodes such as client 110 are generally transmitted within a non-quarantine VLAN, i.e., the PDUs are transmitted without VLAN tags or are transmitted to an edge port associated with a conventional VLAN such as VLAN_A 150, for example. If and when the client 110 introduces a worm or other harmful file into the network, the infected PDU 602 is admitted into and propagates within the non-quarantine VLAN until it is detected by the firewall 105. When the suspicious packet is detected (650), the firewall 105 transmits an intruder detection notice 604 to the AQE server 105. If the intruder detection notice 604 contains only the intruder's MAC address, the AQE server 120, in an enterprise network, for example, transmits SNMP queries for the ARP tables 606 to a plurality of default gateways. The gateway consults (654) their ARP tables and the appropriate gateway responds with a query response 608 with which the AQE server 120 may determine (656) the domain to which the VLAN isolation rules are transmitted. Upon receipt, each of the switches 114-116 in the associated domain executes the script and the applicable isolation rule installed thereon.

After installation of the quarantine rule on each of the switches 114-116 in the domain, PDUs received from the client 110 are automatically segregated into the quarantine VLAN independently of where in the first domain that the client attempts to gain access and independently of the content of the PDU. If the infected client 110 transmits a packet to the first switch 114, for example, the switch 114 applies (660) the VLAN isolation rule and bridges the received packet to the quarantine VLAN. Similarly, if the client 110 moves (670) within the first domain and re-establishes access at the second switch 115, the packet 630 transmitted to the second switch 115 is automatically bridged to the quarantine VLAN in accordance with the VLAN isolation rule, thereby preventing the infected client from moving around the network and extending the scope of the infection. As illustrated, the packets 620, 630 from the infected client 110 may be distributed to the third switch 116 for additional inspection, to firewall 105, or both. One of ordinary skill in the art will appreciate that the PDUs from the infected client 110 may also be subjected to an ACL rule adapted to segregate the suspicious traffic and prevent the client 110 from gaining access to any of the access points in the first domain. In some embodiments, the network user is informed that the offending device has been isolated and then offer software downloads or other solutions to repair the device before allowing the device back onto the network.

The AQE 120 of the preferred embodiment is also adapted to generate scripts, to reverse or otherwise repeal the isolation rules within the domain once it is safe to do so. The reversal scripts may be distributed upon the initiation of the network administrator or automatically after a pre-determined period of time has elapsed, for example. In some embodiments, the information about the MAC and IP addresses of the offending devices are stored so that the operator may later removing the MAC rule and restore service to the quarantined device.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

1. A system for containing traffic in a data communications network, the system comprising:
one or more switching devices;
an intrusion detection system to determine the identity of an intruder; and
a server, operatively coupled to the intrusion detector, adapted to automatically:
generate an isolation rule associating the identified intruder with an isolation action; and
install the isolation rule on each of the one or more one or more switching devices;
wherein each of the one or more switching devices executes the isolation action upon receipt of a protocol data unit (PDU) from the identified intruder.

2. The system of claim 1, wherein the identity of the intruder is a media access control address (MAC) address.

3. The system of claim 1, wherein the identity of the intruder is an Internet Protocol (IP) address.

4. The system of claim 1, wherein the isolation rule is a virtual local area network (VLAN) rule adapted to place one or more PDUs associated with the identified intruder into a quarantine VLAN.

5. The system of claim 1, wherein the isolation rule is an access control list (ACL) rule adapted to segregate one or more PDUs associated with the identified intruder from the PDUs from one or more end stations supported by the one or more switching devices.

6. The system of claim 1, wherein the one or more switching devices are associated with a default gateway, and the server is further adapted to:
identify the default gateway; and
identify the one or more switching devices on which to install the isolation rule.

7. The system of claim 6, wherein the default gateway is one of a plurality of routers, and where the server is adapted to identify the default gateway by issuing a query for address resolution protocol (ARP) information to each of one of a plurality of routers.

8. The system of claim 1, wherein the intrusion detection system is selected from the group consisting of: a firewall and intrusion prevention system.

9. The system of claim 1, wherein the isolation rule is transmitted to the one or more one or more switching devices in a computer readable script.

10. A system for containing a client device in a network comprising one or more routers including a first router associated with a network segment including the client device, the system comprising:
one or more switches operatively connected to the network segment associated with the first router; and
a central management node adapted to:
receive an intrusion detection with a source address from an intrusion detection entity, the source address associated with the client device;
identify the first router from among the one or more routers;
generate a rule to map PDUs having the source address associated with the client device to an penalty virtual local area network (VLAN) separate from other network traffic; and
transmit the rule to each of said one or more switches;
wherein each of the one or more switches causes PDUs having the source address associated with the client device to the penalty VLAN.

11. A method for containing traffic in a data communications network having one or more switching devices, the method comprising the steps of:
identifying an intruder in a network;
automatically generating an isolation rule associating the identified intruder with an isolation action; and
installing the isolation rule on each of the one or more one or more switching devices;
wherein each of the one or more switching devices executes the isolation action upon receipt of a PDU from the identified intruder.

12. The method of claim 11, wherein the intruder is identified by a media access control address (MAC) address.

13. The method of claim 11, wherein the intruder is identified by an Internet Protocol (IP) address.

14. The method of claim 11, wherein the isolation rule is a virtual local area network (VLAN) rule adapted to place one or more PDUs associated with the identified intruder into a quarantine VLAN.

15. The method of claim 11, wherein the isolation rule is an access control list (ACL) rule adapted to segregate one or more PDUs associated with the identified intruder from the PDUs from one or more end stations supported by the one or more switching devices.

16. The method of claim 11, wherein the one or more switching devices are associated with a default gateway, and wherein the method further includes the steps of:
identifying the default gateway; and
identifying the one or more switching devices on which to install the isolation rule.
